(19) United States
(12) Patent Application Publication
(10) Pub. No.: US 2025/0050716 A1
(43) Pub. Date: Feb. 13, 2025

(54) TRANSPARENT ROOF PANEL ASSEMBLY FOR A VEHICLE ROOF

(71) Applicant: INALFA ROOF SYSTEMS GROUP B.V., Oostrum (NL)

(72) Inventors: Theodorus Van Doleweerd, Budel-Dorplein (NL); Stephan Paulus Jan Geurts, Belfeld (Limburg) (NL)

(21) Appl. No.: 18/685,802

(22) PCT Filed: Aug. 25, 2022
(86) PCT No.: PCT/EP2022/073691

§ 371 Date: Feb. 22, 2024

(30) Foreign Application Priority Data
Aug. 25, 2021 (EP) 21193114.2

(51) Int. Cl. B60J 7/043; B32B 17/10; B60Q 3/208; B60Q 3/62; C03C 17/23

(52) U.S. Cl. CPC B60J 7/043; B32B 17/10431; B60Q 3/208; B60Q 3/62; C03C 17/23; B32B 2605/00; C03C 2218/119

(57) ABSTRACT

A transparent roof panel assembly for a vehicle roof comprises a panel and a light source. The panel comprises a first transparent layer having a first main surface and a second main surface opposite the first main surface, a second transparent layer arranged adjacent to the first main surface and a light outcoupling pattern arranged between the first main surface of the first transparent layer and the second transparent layer. The pattern is configured for scattering at least a part of the light from the light source such that light exits the first transparent layer through the second main surface. The pattern comprises scattering particles arranged in a transparent carrier. The particles are pigments in a white ink having a concentration of 0.01-1.5% by weight. The pattern may form an image having a contour formed by a full surface printing, a width being similar to dots forming the image.

### CROSS-REFERENCE TO RELATED APPLICATION(S)

This application is a Section 371 National Stage Application of International Application No. PCT/EP2022/073691, filed Aug. 25, 2022 and published as WO 2023/025895 A1 on Mar. 2, 2023, in English.

### BACKGROUND

The invention relates to a transparent roof panel assembly for a vehicle, wherein a light source is arranged to provide light into a panel of the transparent roof assembly, using the panel as a light guide, and applying suitable structures on the panel to couple out the light at a location of said structures.

A transparent roof assembly for a vehicle is generally known. For example, a glass panel is arranged over an opening in the roof of a vehicle to allow sunlight to enter an interior of the vehicle through the roof. In a known transparent roof assembly, the at least partly transparent panel is fixedly arranged over the opening, while in another known transparent roof assembly the panel is moveably arranged. In particular, the moveably arranged panel may be tiltable and/or slideable.

Further, it is known to arrange a light source in a vicinity of an edge of the at least partly transparent panel such that light emitted by the light source is injected into the panel and the light propagates through the panel, wherein the panel functions as a light guide. In order to direct the light into the interior of the vehicle, light out-coupling structures are provided. For example, light reflecting dots may be arranged on a first surface of the panel. Light propagating in the panel and impinging on such reflective dots on the first surface is then redirected towards on opposite, second surface and leaves the panel at the second surface, thereby illuminating the interior of the vehicle.

In order to achieve light out-coupling as functional illumination, in the known transparent roof assembly, relatively large reflective dots are applied. The dots have a relatively large diameter. When illuminated, in particular with a dark background, e.g. in the night, the reflective dots light up clearly appearing separate light sources, thereby providing the functional illumination. However, e.g. during daytime with a light background, the dots are perceived as dark dots, obstructing the view.

An improvement in this respect is obtained by the roof panel assembly of EP 3 702 217 A1. In this arrangement, semi-transparent or opaque dots are provided on a surface of a glass ply, wherein the dots have a representative diameter smaller than 150 microns, preferably smaller than 80 microns, while the surface coverage is smaller than 10%, preferably smaller than 5%.

Although this arrangement of dots increases the transparency of the panel in daylight, it poses limitations in the design freedom for designing a pattern as the dot coverage is rather low. Therefore, the dot arrangement of this prior art is suitable for evenly printed surfaces, but less suitable for providing image-like graphics and text.

### SUMMARY

In view of the above-mentioned disadvantage of the known transparent roof panel assembly, a transparent roof panel assembly configured to provide functional illumination while further reducing the obstruction of the view is disclosed.

According to an aspect of the invention, a very low pigment concentration in the ink (0.01-1.5% against 10-50% in a common non-transparent white ink) leads to a transparency of the panel in daylight being very good, even when larger dots are used, or with a relatively high dot density. Nonetheless, the scattering properties at incident light from the first layer are still surprisingly good thereby making an image visible from the interior of the vehicle. Due to the very low pigment concentration the refractive index (RI) of the light outcoupling pattern will indeed mainly be determined by the carrier composition.

In one possible embodiment, the RI of the first transparent layer is equal to or lower than the RI of the carrier composition. In this case the light can easily enter the carrier composition and will reflect in a diffuse manner (scatters) against the scattering particles or pigments that the light meets in the carrier composition.

In another embodiment, the RI of the first transparent layer is higher than the RI of the carrier composition. In that case the light will partly reflect at the boundary between the first transparent layer and the carrier composition due to TIR. However, because of the scattering particles at or close to the boundary (“evanescence wave”) (which most likely take care of the scattering) there is still a scattering of a part of the light taking place. This embodiment is believed to be most efficient in yielding light into the interior of the vehicle.

The pigments of the ink may be formed from inorganic material, in particular titanium dioxide (TiO2), barium sulphate (BaSO4), calcium carbonate (CaCO3), zinc sulphide (ZnS), zirconium dioxide (ZrO2). A combination of barium sulphate and titanium dioxide works well as the barium sulphate acts as a spacer increasing the efficiency of the titanium dioxide pigment, thereby reducing cost.

In a particular embodiment, the RI of the pigments is substantially at the level of the RI of the carrier composition, resulting in a low obstruction of daylight and therefore a high transparency. However, the RI of the pigments is preferably higher than the RI of the carrier composition for improving the outcoupling of light by the pigments.

The carrier composition may comprise mainly a transparent varnish.

In one embodiment, the light outcoupling pattern is printed on the second transparent layer which is flexible, preferably a polymer foil.

Printing on a flexible layer has the advantage that it can be held in a flat condition while printing. If the first transparent layer is rigid and not flat, the printing pattern can be compensated for the eventual shape of the flexible layer next to the curved rigid layer.

For example, the first transparent layer may be a rigid, preferably a glass, ply and the second transparent layer is preferably covered by a second rigid ply to form a multilayer panel in which the printed, flexible second layer is an interlayer.

It is preferred that the out-coupling pattern comprises dots of the carrier composition comprising the scattering particles (diluted ink comprising pigments).

The dots are normally applied in a particular pattern. A dot coverage is a ratio of a total dot surface area of all dots in a unit area over a total surface area of the unit area. The dot coverage close to the light source is preferably lower compared to the dot coverage farther away from the light source. With a higher dot coverage, more light is coupled out, while a lower dot coverage, less light is coupled out. Close to the light source, more light is available, while farther away from the light source, the amount of light is less. In order to achieve a uniform light output over the transparent area, the dot coverage close to the light source may be reduced and farther away from the light source, the dot coverage may be increased. Of course, it is noted that in another embodiment, another light effect may be desired and then a local dot coverage may be selected differently.

If the dots form an image having a contour, said contour is preferably formed by a contour line made by full surface printing, a width of the contour line being preferably similar to a representative dot diameter of the dots forming the image (for example 80-150 micrometer). Such contour line made by full surface printing leads to an image having a very sharp outline. If the line is not wider than the representative dot diameter, it will not be visible in daylight conditions.

Because of the transparency of the diluted ink (and the resulting low pigment concentration), it is also possible that the ink forms a continuous layer between the first and second transparent layers, while still obtaining a good transparency of the panel.

An aspect of the invention also includes a method of making an image on a boundary between a rigid first layer, preferably a glass ply, and a flexible second layer, preferably a polymer sheet. It comprises the steps of printing ink on one surface of the flexible second layer, curing the ink partly in a first curing step such that it does not stick anymore, but is still flexible, arranging the flexible second layer with said one surface on the rigid first layer with the printed ink in between, curing the ink fully in a second curing step and thereby adhere the flexible second layer and the ink to the rigid first layer.

In this method including the two-step curing it is possible to print the flexible second layer in one place, e.g. a printing workshop and assemble it with the rigid first layer in another place, e.g. a glass factory. For example, the flexible second layer may be rolled-up into a roll after the first curing step and may be unrolled again before it is arranged on the rigid first layer. In this way, the printed flexible second layer can easily be stored and/or transported before the final product is made.

The first and second curing step may be done by heat-curing or UV-curing, and in the first case the second curing step may be carried out by means of the heat used for attaching the flexible second layer to the rigid first layer by heat-lamination.

Screen printing is a method that is very suitable to be used in combination with glass and other transparent materials used for a transparent roof system.

Inkjet printing is a manufacturing technique that allows for very small droplets of ink with relatively high accuracy in droplet size and droplet positioning, enabling to provide for a highly accurate and uniform distribution of the dots in the out-coupling pattern.

Inkjet printing may be a suitable manufacturing method for printing the dots on a flexible foil or web of material that is later used as an interlayer in a multi-layered panel. For example, the dots may be printed on a PVB or EVA foil. The printed PVB or EVA foil may then be arranged between two plies of glass. In particular, the printed surface of the foil may be arranged on a surface of the glass ply in which light is to be coupled in such that the printed dots are in contact with such glass ply for coupling out the light.

An ink applied by either screen printing or inkjet printing or any other suitable technique, may be a white reflective ink to provide for the light-redirecting property. Further, a photoluminescent ink may be applied alternatively or additionally. Of course, the inkjet ink may be both reflective and photoluminescent. A photoluminescent ink may for example convert UV-light into visible light. Therefore, in a particular embodiment, at least two light sources may be provided: one light source outputting visible light that is reflected and one light source outputting UV light that is converted. Moreover, the light out-coupling pattern may be designed such that a certain light effect may be selectively obtained by suitable selecting one of the available light sources.

In an embodiment, the light source comprises multiple LED's. For example, single LED's may be arranged regularly around a perimeter of the panel to provide a uniform light output over the transparent area. In another example, multiple LED's may be arranged at substantially the same position, wherein each LED may output a different color of light, e.g. three LED's may output red, green and blue light, respectively. Thus, virtually any color of light may be generated by controlling the light output per LED, as well known in the art. In general, using multiple LEDs allows to provide for light effects.

An aspect of the invention also includes a roof assembly comprising the roof panel assembly as described above.

### BRIEF DESCRIPTION OF THE DRAWINGS

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description with reference to the appended schematical drawings, in which:

FIG. 1 is a perspective view of a vehicle roof with an open roof assembly,

FIG. 2A is a cross-section of an embodiment of a multi-layered glass panel for use in the present invention,

FIG. 2B is an exploded cross-section according to a first embodiment of providing the glass panel according to FIG. 2A,

FIG. 2C is an exploded cross-section according to a second embodiment of providing the glass panel according to FIG. 2A,

FIG. 3 is an enlarged cross-section of a small part of the glass panel of FIG. 2A showing a print dot containing scattering particles.

### DETAILED DESCRIPTION OF THE ILLUSTRATIVE EMBODIMENTS

Aspects of the present invention will now be described with reference to the accompanying drawings, wherein the same reference numerals have been used to identify the same or similar elements throughout the several views.

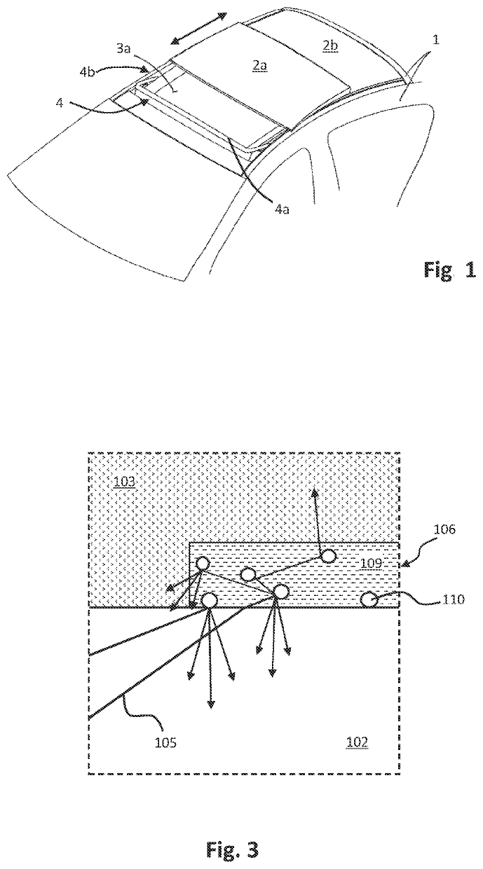

FIG. 1 illustrates a vehicle roof 1 having an open roof assembly arranged therein. The open roof assembly comprises a moveable panel 2a and a fixed panel 2b. The moveable panel 2a is also referred to as a closure member, since the moveable panel 2a is moveable over a first roof opening 3a such to enable to open and to close the first roof opening 3a. A wind deflector 4 is arranged at a front side of the first roof opening 3a.

In the illustrated embodiment, the moveable panel 2a may be in a closed position, which is a position wherein the moveable panel 2a is arranged over and closes the first roof opening 3a and thus usually is arranged in a plane of the vehicle roof 1. Further, the moveable panel 2a may be in a tilted position, which is a position wherein a rear end RE of the moveable panel 2a is raised as compared to the closed position, while a front end FE of the moveable panel 2a is still in the closed position. Further, the moveable panel 2a may be in an open position, which is a position wherein the moveable panel 2a is slid open and the first roof opening 3a is partly or completely exposed. It is noted that in FIG. 1A, the moveable panel 2a is in the open position.

It is noted that the illustrated vehicle roof 1 corresponds to a passenger car. The present invention is however not limited to passenger cars. Any other kind of vehicles that may be provided with a moveable panel are contemplated as well.

Further details of the roof assembly and roof panel are disclosed in US 2020/0276891 A1 the whole content of which is incorporated herein by reference thereto.

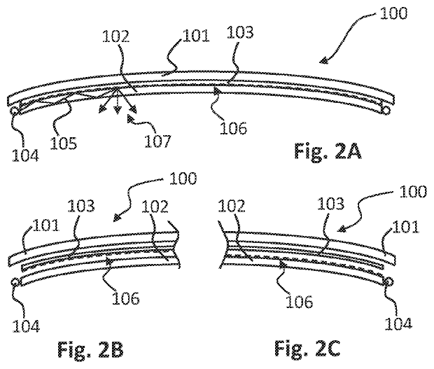

The open roof assembly further comprises an illumination system. FIG. 2A of US 2020/0276891 A1 shows a pattern of reflective dots that are arranged on a surface of the moveable panel 2a and/or the fixed panel 2b. In this prior art system, a light source 21, e.g. an LED or an incandescent lamp or any other suitable light source, directs light into a light guide 22, which may be a cylindrical unit of transparent material. As known in the art, light may propagate through the light guide 22. Due to total internal reflection at a boundary between the material of the light guide 22 and the surrounding air, the light is retained in the light guide 22. Where the surface of the light guide 22 is not in contact with air, light may exit the light guide 22 or be reflected back into the light guide 22 at an angle such that the light may exit the light guide 22 at an opposite surface. With a known suitable configuration, the light originating from the light source 21 propagates through the light guide 22 and into a transparent panel on which the out-coupling pattern 20 is provided. For example, the out-coupling pattern 20 may be formed from a reflective paint or ink, e.g. a white paint or ink. As above mentioned, the dots of reflective paint or ink prevent total internal reflection of the light rays. Instead, the light rays impinging on the reflective dots reflect under another angle and are enabled to exit the transparent panel at the opposite surface. With a suitable configuration, it is thus enabled to direct the light from the light source 21 to the interior of a vehicle.

FIG. 2A of the present application shows a cross-section of a multi-layered glass panel 100 for use in the open roof assembly according to FIG. 1, wherein an exterior glass ply 101 (third or optional layer) and an interior glass ply 102 (first layer) are attached by an interlayer 103 (second layer). Such an interlayer is known in the art. For example, the interlayer 103 may be formed of EVA or PVB. Other materials are known and suitable as well.

At a side edge of the interior glass ply 102, a light source 104 is provided. The light source 104 may be any light source suitable for coupling light 105 into the interior glass ply 102 through its side edge. For example, known light sources are LED's directing light directly into the side edge of the interior glass ply 102 or, alternatively or additionally, an elongated, side-emitting light guide arranged next to the side edge of the interior glass ply 102 (cf. FIG. 2A).

As hereinabove also described in relation to FIG. 2A of US 2020/0276891, an out-coupling pattern 106 is provided at a surface of the interior glass ply 102. In particular, the out-coupling pattern 106 is arranged at an interface between the interior glass ply 102 and the interlayer 103. The interior glass ply 102 and the interlayer are adjacent to each other, which means they are attached directly to each other or through the outcoupling pattern 106. As shown, a ray of light 105 propagates through the interior glass ply 102 and may impinge on a scattering particle of the out-coupling pattern 106. Upon impingement, the ray of light 105 is at least partly reflected and reflected light rays 107 are enabled to leave the interior glass ply 102 at an opposite surface of the interior glass ply 102 and is thus emitted into an interior passenger compartment 108 of a vehicle.

FIG. 2B and FIG. 2C show a first and a second embodiment, respectively, for manufacturing the multi-layered glass panel 100 of FIG. 2A. In the first embodiment of FIG. 2B, the out-coupling pattern 106 is provided on a surface of the interlayer 103. The surface with the out-coupling pattern 106 thereon is then attached to a surface of the interior glass ply 102, e.g., by application of heat and pressure in an autoclave.

The interlayer material may be a flexible foil and the out-coupling pattern 106 may be provided on the interlayer material by a simple processing technique, e.g., inkjet printing. Since the flexible foil may for example be stored on a roll, the flexible foil may be provided with the out-coupling pattern 106 using a common roll-to-roll inkjet printer.

For vehicle roofs, the multi-layered glass panel 100 usually is curved in two dimensions. When printing on the flat foil of interlayer material, the printed pattern may be adapted and prepared to the required stretching of the interlayer foil when the foil is provided on the curved interior glass ply 102. For example, for achieving a pattern of dots aligned on a rectangular grid the dots of the out-coupling pattern 106 as printed on the flat foil will need to be positioned on a different, non-rectangular grid. The non-rectangular grid is in such embodiment determined in accordance with the expected stretch and will, after stretch on the interior glass ply 102, be substantially rectangular.

When printing is done on the flexible interlayer 103, it can take place in a different facility than the glass factory where the glass panels are made. It is important then that the ink is sufficiently stabilized and not sticky or fluid anymore so that the interlayer 103 can be rolled up into rolls that can easily be stored and/or transported. For this purpose, the ink on the interlayer 103 is partially cured in a first step. It is not fully cured in order to ensure that the interlayer 103 and the ink thereon are properly adhered to the interior glass ply 102. This adherence is obtained if the ink is fully cured in a second step when the interlayer 103 and the interior glass ply 103 (and possibly also exterior glass ply 101) are assembled. This is normally done by heat so that laminating the layers and fully curing the ink are done simultaneously. Alternatively or additionally, the first and/or second curing step could be done by means of UV radiation.

In another embodiment the out-coupling pattern 106 is applied directly on the interior glass panel 102. A suitable technique is screen printing, although other techniques may be used as well. For example, inkjet printing may be applied.

Applying the out-coupling pattern 106 on the interior glass panel 102 may be performed prior to or after bending of the interior glass panel 102. Prior to bending, the interior glass panel 102 is a flat glass plate, which eases the application of the out-coupling pattern 106 and many techniques can easily be used. Still, there may be a risk of damaging the printed out-coupling pattern 106 upon bending the interior glass panel 102.

After bending, it may become more challenging to apply the out-coupling pattern 106. For example, using inkjet printing, a robotic arm may follow the curved contours of the surface of the interior glass panel 102, while applying the pattern 106, or the curved interior glass panel 102 may be temporarily flattened on a table, e.g., a suction table, which is suitable for using screen printing.

Printing will be performed with ink having a very low pigment concentration. The low concentration can be obtained by diluting regular ink with a transparent varnish, for example 0.1-5%, (preferably 0.1-2%) of white ink diluted with 95-99.9% (98-99.9%) varnish (based on weight). Commonly, pigment concentrations in white inks are in a range of about 10-50% by weight. In the diluted ink, a pigment concentration of about 0.01-1.5% (preferably 0.01-0.15-0.6-1.5%, or even 0.7-1.0%) by weight may be assumed. Pigments are preferably made from inorganic material, for example: titanium dioxide (TiO2), barium sulphate (BaSO4), calcium carbonate (CaCO3), zinc sulphide (ZnS), zirconium dioxide (ZrO2). Calcium carbonate has a refractive index (RI) of 1.486-1.658 and barium sulphate has one of 1.636. The RI of calcium carbonate may be close to that of the transparent carrier composition (vehicle) if this mainly consists of varnish which has a RI of 1.4528-1.512. A first main ingredient of varnish is Hydroxyethyl methacrylate having a RI of 1.4528 and the second main ingredient is polyester acrylate oligomer having a RI of 1.501-1.512. So, the refractive ingredient of the varnish will be somewhere between 1.4528 and 1.512 and can be varied. If a varnish “540-05” is used (RI=1.4835) and mixed with 2% ink “540-9005”, the resulting RI=1.4837. To improve outcoupling of light by pigments that are not close to the boundary with the glass, the RI of the pigments is preferably higher than that of the carrier composition.

If full surface printing is used (this can be obtained by causing the dots to touch each other), then an ink concentration of 0.5% (pigment concentration between 0.05% and 0.15% by weight) is considered to provide a good balance between transparency and light scattering, i.e. leading to a light reflection of 13.6%. In case of dot printing, the ink concentration could be as high as 2% (pigment concentration between 0.2% and 0.6% by weight) for a proper balance, leading to a light reflection of 20.5%.

Full surface printing may for example be used if the dots form an image having a contour. The contour is then preferably formed by a contour line made by full surface printing. The width of the contour line is preferably similar to a representative dot diameter of the dots forming the image (for example 80-150 micrometer). Such contour line made by full surface printing leads to an image having a very sharp outline. If the line is not wider than the representative dot diameter, it will not be visible in daylight conditions. Representative dot diameter means that if a dot is not circular, the representative diameter is the diameter of a circular dot having the same surface area as the non-circular dot. For example, the dots may have a substantially square dot shape with a size of about 1.5×1.5 mm. A dot surface area of such dots is 2.25 mm². For ease of comparison herein, such dots are referred to as having a representative diameter of about 1.69 mm as a circular dot with a diameter of 1.69 mm also has a dot surface area of 2.25 mm². While the present invention is not limited to any kind of form or shape of the reflective dots, a representative diameter may be determined and assigned based on their dot surface area.

An example of an ink that can be used is plastisol ink. Plastisol inks are composed of fine particles of PVC polymers or copolymer resins and a liquid plasticizer. Typical plastisol formulas will also contain stabilizers, fillers, thickeners etc. When heated to around 177 degrees Celsius, the plastic particles dissolve and the mixture turns into a gel of high viscosity that can no longer be poured. On cooling below 60 degrees Celsius, a flexible, permanently plasticized solid product results. In the method using two steps curing, the first curing step can be performed at a medium temperature (e.g., 82-121 degrees C.), and the second curing step at a higher temperature (138-160 degrees C.). Of course, two step curing can also be done with other inks, such as those based on epoxy resin.

In an embodiment, the local total surface area coverage may be adapted to obtain a more uniform light image. In such embodiment, the total surface area coverage near the light source may be kept low, while farther away the local total surface area coverage may be increased.

It is noted that the actual luminance is dependent on the light output of the light source. Using multiple LEDs along the panel 2 may be expected to provide for more light output compared to an embodiment with only a single light source and light guide. It is however noted that in an embodiment with a light guide, multiple light sources may be used as well, e.g., with the aid of a branched/forked light guide with multiple light sources directing light into the light guide. Further, the light source may have a selectable light output (dimmable) in order to provide for the possibility to adapt the light output. It has been shown that with high intensity light sources such as suitable LEDs, the total pigment concentration may be further reduced while maintaining sufficient light output.

FIG. 3 shows a detailed cross-section of the first transparent layer or glass pane 102, the second transparent layer or interlayer 103 and the outcoupling pattern or ink dot 106. The ink dot 106 mainly consists of the carrier composition 109 and scattering particles or pigments 110 in a very low concentration. There are two possible ways in which the invention can work. In the first possible embodiment (shown by the right light ray 105 in FIG. 3), the RI of the first transparent layer 102 is equal to or lower than the RI of the carrier composition 109 of the outcoupling pattern 106. In this case the light can easily enter the carrier composition 109 and will reflect in a diffuse manner (scatters) against the scattering particles or pigments 110 that the light ray 105 meets in the carrier composition 109.

In the other embodiment (illustrated by the left light ray in FIG. 3), the RI of the first transparent layer 102 is higher than the RI of the carrier composition 109. In that case the light will partly reflect at the boundary between the first transparent layer 102 and the carrier composition 109 due to TIR. However, because of the scattering particles 110 at or close to the boundary (“evanescence wave”) there is still a scattering of a part of the light taking place.

In an example, the first layer 102 is a glass layer having a RI of 1.52. If the carrier composition 109 is varnish, it will have a RI of 1.4528-1.512, so it will be smaller than that of the first layer 102, and that means that in this example the second embodiment illustrated by the left ray in FIG. 3 is accomplished here. The light into the interior of the vehicle is most likely coming from the scattering particles 110 that lie at or close to the boundary of the glass first layer 102 and the carrier composition 109. This means that this second embodiment would be most efficient in relation to the light yield into the interior of the vehicle.

If PVB or EVA is used for the interlayer 103, the RI will be 1.48-1.49. If TPU is used, the RI will be 1.50. The RI of the first glass layer 102 is 1.52, so the RI of the first glass layer 102 is greater than that of the interlayer 103. Furthermore, the RI of the carrier composition 109 is generally smaller than or substantially equal to the RI of the interlayer 103, in particular to keep the light within the carrier composition 109. In such case, if some of the light still would enter from the first transparent layer 102 into the carrier composition 109, the light would be kept within the carrier composition 109.

The invention also includes the following embodiment:

A transparent roof panel assembly for a vehicle roof, the roof panel assembly comprising
a panel having at least a transparent area, the panel being configured to be arranged over an opening in the vehicle roof to allow visible light to pass in a first direction through the transparent area, the first direction extending between an exterior of the vehicle and an interior of the vehicle and substantially perpendicular to a surface of the panel
a light source arranged to provide light in the panel in a second direction, wherein the second direction is substantially perpendicular to the first direction,
   the panel comprising:
a first transparent layer having a first main surface and a second main surface opposite the first main surface,
the light source being configured to provide light in the first transparent layer such that at least a part of the light propagates between the first main surface and the second main surface through the first transparent layer,
a second transparent layer arranged adjacent to the first main surface; and
a light outcoupling pattern arranged between the first main surface of the first transparent layer and the second transparent layer, wherein the light outcoupling pattern is configured for scattering at least a part of the light propagating in the first transparent layer such that at least a part of the propagating light exits the first transparent layer through the second main surface,
   wherein the light outcoupling pattern forms an image created by dots of transparent carrier composition comprising scattering particles, and
   wherein the image has a contour, said contour being formed by a full surface printing contour line, a width of which is preferably similar to a representative dot diameter of the dots forming the image.

From the above description it follows that the invention provides a roof panel assembly that has a very good transparency, while still scattering light in a favourable manner from the panel to the interior of the vehicle. The invention also enables full surface printing thereby enhancing contours of images or text or thereby covering the complete transparent part of the panel surface. The method according to the invention provides an efficient production of panel assemblies.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in expectedly any appropriately detailed structure. In particular, features presented and described in separate dependent claims may be applied in combination and any advantageous combination of such claims are herewith disclosed.

Further, the terms and phrases used herein are not intended to be limiting, but rather to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described it is apparent that the same may be varied in many ways. Such variations are not to be regarded as a departure from the spirit and scope of the invention, and all such modifications as would be apparent to one skilled in the art are intended to be included within the scope of the following claims.

1. A transparent roof panel assembly for a vehicle roof of a vehicle, the transparent roof panel assembly comprising:
a panel having at least a transparent area, the panel being configured to be arranged over an opening in the vehicle roof to allow visible light to pass in a first direction through the transparent area, the first direction extending between an exterior of the vehicle and an interior of the vehicle and substantially perpendicular to a surface of the panel;
a light source arranged to provide light in the panel in a second direction, wherein the second direction is substantially perpendicular to the first direction,
wherein the panel comprises:
a first transparent layer having a first main surface and a second main surface opposite the first main surface,
the light source being configured to provide light in the first transparent layer such that at least a part of the light propagates between the first main surface and the second main surface through the first transparent layer;
a second transparent layer arranged adjacent to the first main surface; and
a light outcoupling pattern arranged between the first main surface of the first transparent layer and the second transparent layer, wherein the light outcoupling pattern is configured for scattering at least a part of the light propagating in the first transparent layer such that at least a part of the light propagating in the first transparent layer exits the first transparent layer through the second main surface,
wherein the light outcoupling pattern comprises scattering particles arranged in a transparent carrier composition, and
wherein the scattering particles are pigments in a white ink having a pigment concentration of 0.01-1.5% by weight.

2. The transparent roof panel assembly of claim 1, wherein the pigments are formed from inorganic material.

3. The transparent roof panel assembly of claim 1, wherein a refractive index of the pigments is substantially equal to or higher than a refractive index of the transparent carrier composition.

4. The transparent roof panel assembly of claim 1, wherein the transparent carrier composition comprises mainly a transparent varnish.

5. The transparent roof panel assembly of claim 1, wherein a refractive index of the second transparent layer is similar to or higher than a refractive index of the transparent carrier composition.

6. The transparent roof panel assembly of claim 1, wherein a refractive index of the second transparent layer is smaller than a refractive index of the first transparent layer.

7. The transparent roof panel assembly of claim 1, wherein the light outcoupling pattern is printed on the second transparent layer.

8. The transparent roof panel assembly according to claim 7, wherein the first transparent layer is a first rigid ply.

9. The transparent roof panel assembly of claim 1, wherein the scattering particles arranged in the transparent carrier composition forming the light out-coupling pattern are provided in the form of dots.

10. The transparent roof panel assembly of claim 9, wherein the dots are applied in a particular pattern and a dot coverage is a ratio of a total dot surface area of all dots in a unit area over a total surface area of the unit area and wherein the dot coverage close to the light source is lower compared to the dot coverage farther away from the light source.

11. The transparent roof panel assembly of claim 9, wherein the dots form an image having a contour, said contour being formed by a full surface printing contour line.

12. A transparent roof panel assembly for a vehicle roof of a vehicle, the roof panel assembly comprising:
a panel having at least a transparent area, the panel being configured to be arranged over an opening in the vehicle roof to allow visible light to pass in a first direction through the transparent area, the first direction extending between an exterior of the vehicle and an interior of the vehicle and substantially perpendicular to a surface of the panel;
a light source arranged to provide light in the panel in a second direction, wherein the second direction is substantially perpendicular to the first direction,
the panel comprising:
a first transparent layer having a first main surface and a second main surface opposite the first main surface,
the light source being configured to provide light in the first transparent layer such that at least a part of the light propagates between the first main surface and the second main surface through the first transparent layer;
a second transparent layer arranged adjacent to the first main surface; and
a light outcoupling pattern arranged between the first main surface of the first transparent layer and the second transparent layer, wherein the light outcoupling pattern is configured for scattering at least a part of the light propagating in the first transparent layer such that at least a part of the light propagating in the first transparent layer exits the first transparent layer through the second main surface,
wherein the light outcoupling pattern forms an image created by dots of a transparent carrier composition comprising scattering particles, and
wherein the image has a contour, said contour being formed by a full surface printing contour line.

13. A method of making an image on a boundary between a rigid first layer and a flexible second layer, the method comprising: forming the image by a light outcoupling pattern comprising scattering particles arranged in a transparent carrier composition, and wherein as the scattering particles are chosen pigments in a white ink having a pigment concentration of 0.01-1.5%.

14. The method of claim 13, further comprising:
printing the ink on one surface of the second layer;
curing the ink partly in a first curing step such that it does not stick anymore, but is still flexible;
arranging the flexible second layer with said one surface on the rigid first layer with the printed ink in between; and
curing the ink fully in a second curing step and thereby adhere flexible second layer and the ink to the rigid first layer.

15. The method of claim 13, further comprising:
rolling the flexible first layer into a roll after the first curing step; and
unrolling the ml of the flexible first layer before the flexible first layer is arranged on the rigid first layer.

16. The method of claim 14, wherein the first and/or second curing step is done by heat-curing or UV-curing.

17. (canceled)

18. The method of claim 14, wherein the second curing step comprises using heat used for arranging the flexible second layer on the rigid first layer by lamination.

19. The transparent roof panel assembly of claim 11, wherein a width of said contour is similar to a representative dot diameter of the dots forming the image.

20. The transparent roof panel assembly according to claim 8, wherein the first rigid ply is a glass ply and the second transparent layer is covered by a second rigid ply.

21. The transparent roof panel assembly of claim 2, wherein the inorganic material comprises at least one of titanium dioxide (TiO2), barium sulphate (BaSO4), calcium carbonate (CaCO3), zinc sulphide (ZnS), or zirconium dioxide (ZrO2).
